(19) United States
(12) Patent Application Publication
(10) Pub. No.: US 2015/0022104 A1
(43) Pub. Date: Jan. 22, 2015

(54) LED LIGHTING APPARATUS HAVING IMPROVED FLICKER PERFORMANCE

(71) Applicant: Don Won Lee, Suwon-si (KR)

(72) Inventor: Don Won Lee, Suwon-si (KR)

(21) Appl. No.: 14/382,187

(22) PCT Filed: Jan. 31, 2013
(86) PCT No.: PCT/KR2013/000778

§ 371 Date: Aug. 29, 2014

(30) Foreign Application Priority Data
Mar. 1, 2012 (KR) 10-2012-0021522

(51) Int. Cl. H05B 33/08

(52) U.S. Cl. CPC H05B 33/0827; H05B 33/0809
USPC 315/193; 315/205

(57) ABSTRACT

Provided is a lighting apparatus using LEDs (light-emitting diodes having improved flicker performance. In general, in a direct-drive LED lighting apparatuses of the related art which use no switching-mode power supply (SMPS), percent flicker (hereinafter referred to as “% F”) is 100%. In contrast, the % F of the LED lighting apparatus having improved flicker performance according to the present invention is 40% or less that is equivalent to the % F of fluorescent lamps using a magnetic ballast.

### BACKGROUND

The present invention relates, in general, to a lighting apparatus using light-emitting diodes (LEDs) and, more particularly, to an LED lighting apparatus having improved flicker performance which is driven directly by a rectified voltage without using a typical switching mode power supply (SMPS).

Light-emitting diodes (LEDs) are electrophotonic conversion semiconductor devices that emit light when current flows therethrough, and are widely used for indicators, backlights, etc. The electrophotonic conversion efficiency of LEDs is higher than that of incandescent lamps and that of fluorescent lamps in response to the development of technologies, and their range is expanding to general lighting systems.

Among methods of driving an LED, a plurality of methods of driving an LED lamp using a rectified voltage without a typical switching mode power supply (SMPS) (hereinafter referred to as “LED direct drive methods”), including Patent No. 10-1110380 of the inventor, was introduced.

Reference will now be made to conventional methods of driving an LED using a DC voltage with reference to FIG. 1 to FIG. 4.

<Related Art 1>

As shown in FIG. 1, a conventional LED lighting apparatus includes an alternating current (AC) power supply 910 which supplies an AC voltage, a rectifier circuit 940 which converts the AC voltage into a DC rectified voltage Vrect, an LED block 970 which is a load to be driven in response to an output from the rectifier circuit 940, and a current limiting device 930 which limits a current flowing through the LED block 970.

However, in the conventional LED lighting apparatus, no current flows at or lower than the threshold voltage of the LED block 970. The LED block 970 which is an electrophototic conversion device does not emit light in this voltage range but emits maximum light at the maximum instantaneous rectified voltage. Consequently, the light output is not uniform and fluctuations with the time, which is problematic.

The problem will be described in detail with reference to FIG. 2 and FIG. 3.

In FIG. 2, a current-voltage characteristic curve 950 is a characteristic curve of an AX2200, an AC drive LED device available from Seoul Semiconductor Co. Ltd. Since the AX2200 is a device that operates with AC power, an LED lighting apparatus using this device does not need a rectifier circuit 940. However, since the same profile of the current-voltage characteristic curve is identical to that of a typical diode characteristic curve (the current increases exponentially while the voltage increases linearly), the characteristic curve of the AX2200 is used herein for the purpose of numerical explanation. (In FIG. 2, the horizontal axis is effective voltage, and the vertical axis is effective current. Herein, in the description of the concept of the present invention, the axes are set as instantaneous voltage and instantaneous current, respectively, for the sake of convenience of explanation.)

In FIG. 2, it is apparent that the threshold voltage at the current-voltage characteristic curve 950 is 62.5 V. Each of a first linear model 951 and a second linear model 952 is produced by modeling the characteristic curve 950 into a straight line in a simple manner. The first linear model 951 is usable when modeling the instantaneous rectified voltage Vrect varying in the range from 0 to 112.5 V. It is apparent that the current is 0 mA at 62.5 V and 31 mA at 112.5 V. In addition, the second linear model 952 is usable when modeling the instantaneous rectified voltage Vrect varying in the range from 0 to 87.5 V. It is apparent that the current is 0 mA at 62.5 V and 11 mA at 87.5 V.

FIG. 3 shows an example in which the first linear model 951 and the second linear model 952 are applied to a power frequency of 50 Hz.

First, in the first linear model 951 in which the maximum rectified voltage 112.5 V is applied, the rectified voltage Vrect is presented with a waveform 951V, and the rectified current is presented with a waveform 951A. In the second linear model 952 in which the maximum rectified voltage 87.5 V is applied, the rectified voltage Vrect is presented with a waveform 952V, and the rectified current is presented with a waveform 952A.

Since only the size of an input rectified voltage is changed while the LED block 970 is unchanged, the threshold voltage of the LED block is equally 62.5 V but the lighting start time of the LED block 970 is earlier as the effective value of the rectified voltage Vrect increases. For instance, at a power frequency of 50 Hz and maximum rectified voltages 87.5 V and 112.5 V, the points of time when passing through the threshold voltage 62.5 V of the LED block 970 are calculated 2.53 ms and 1.87 ms, respectively. These points of time are converted into rectified voltage phases 45.5° (=2.53/5×90) and 33.7° (=1.87/5×90).

That is, when the maximum rectified voltage is supplied at 87.5 V, the rectified voltage is equal to or lower than the threshold voltage of the LED block 970 before the rectified voltage phase 45.5°. Consequently, no current flows and thus no light is emitted. In addition, when the maximum rectified voltage is supplied at 112.5 V, the rectified voltage is equal to or lower than the threshold voltage of the LED block 970 before the rectified voltage phase 33.7°. Consequently, no current flows and thus no light is emitted.

In addition, at the rectified voltage phase 90°, the maximum currents flow, as presented with the current waveform 952A and the current waveform 951A.

Summarizing FIG. 3, the higher the effective value of the rectified voltage Vrect is, the earlier the lighting start time of the LED lighting module becomes. This consequently increases the lighting time. However, since no light is emitted at a voltage equal to or lower than the threshold voltage of the LED block 970, there is a section where the minimum instantaneous light output is zero.

<Related Art 2>

FIG. 4 is a view quoted from Korean Patent No. 10-1110380 of the inventor. Describing the characteristics of FIG. 4 in relation to the present invention, 1) the conventional LED block 970, namely the load, is divided into a number of sub-light emitting blocks (i.e. a first light emitting block 10, a second light emitting block 11 and a third light emitting block 12). 2) A parallel switch block (including a first switch S11 and a second switch S12) and a controller 4 are provided, which adjust the number of the lighted sub-light emitting blocks by changing the path along which a load current flows depending on the instantaneous voltage. 3) In addition, the load current was limited using a current limiting device CS2.

When the instantaneous voltage is low, a small number of light emitting blocks which are arranged in series is driven. Then, the threshold voltage of the LED blocks, which serves as a load, is lowered below that of the Conventional Method 1. Since the current flows at a relatively earlier voltage phase, the time during which no light is emitted from the LED block is reduced.

Referring to the case in which one sub-light emitting block is lighted, no light is emitted at a voltage equal to or lower than the threshold voltage of the sub-light emitting block. Therefore, the section where the minimum instantaneous light output is 0 is not removed, which is problematic.

### PRIOR ART DOCUMENT

Patent No. 10-1110380, Patent No. 10-0942234,
Patent No. 10-0971757, Patent No. 10-0997050,
Patent No. 10-0979432

### SUMMARY OF THE INVENTION

Accordingly, the present invention has been made keeping in mind the above problems occurring in the prior art, and an object of the present invention is to provide an LED lighting apparatus having improved flicker performance in which the difference between the maximum instantaneous light output and the minimum instantaneous light output from the LED lighting apparatus is decreased.

In order to accomplish the above object(s), the present invention provides an LED lighting apparatus having improved flicker. The LED lighting apparatus includes: an AC power supply which supplies a first-phase AC voltage and a second-phase AC voltage; first and second rectifier circuits which convert the AC voltages into DC rectified voltages; first and second LED blocks each including one or more LEDs as a load; first and second current limiting devices each of which limits an amount of current; a first LED lighting block including the first rectifier circuit which rectifies the first-phase AC voltage, a first LED block which is driven by an output from the first rectifier circuit, and the first current limiting device which limits the amount of current of the first LED block; and a second LED lighting block including the second rectifier circuit which rectifies the second-phase AC voltage, a second LED block which is driven by an output from the second rectifier circuit, and the second current limiting device which limits the amount of current of the second LED block. When a point of time where each of the AC voltages supplied to a corresponding LED lighting block of the first and second LED lighting blocks passes through a zero voltage and starts to increase is set to a voltage phase 0°, a current starts to be supplied to each of the LED lighting blocks and light emission starts before a voltage phase 10°, and a percent flicker of each of the LED lighting blocks is 100%.

In addition, it is preferred that the LED lighting apparatus further include a third LED lighting block including an AC power supply which supplies a third-phase AC voltage; a third rectifier circuit which rectifies the third-phase AC voltage; a third LED block which is driven by an output from the third rectifier circuit; and a third current limiting device which limits an amount of current of the third LED block. When a point of time where each of the AC voltages supplied to a corresponding LED lighting block of the first and second LED lighting blocks passes through a zero voltage and starts to increase is set to a voltage phase 0°, a current starts to be supplied to each of the LED lighting blocks and light emission starts before a voltage phase 40°, and a percent flicker of each of the LED lighting blocks is 100%.

Furthermore, it is preferred that the first LED block include a light emitting block in which two or more sub-LED blocks are connected in series, and the first LED lighting block further includes a first switch block (composed of one or more switches) which adjusts a number of the sub-LED blocks that are lighted by changing a current flow and a first controller (which controls the first current limiting device and the first switch block), that the second LED block include a light emitting block in which two or more sub-LED blocks are connected in series, and the second LED lighting block further includes a second switch block (composed of one or more switches) which adjusts a number of the sub-LED blocks that are lighted by changing a current flow and a second controller (which controls the second current limiting device and the second switch block), and that the third LED block include a light emitting block in which two or more sub-LED blocks are connected in series, and the third LED lighting block further includes a third switch block (composed of one or more switches) which adjusts a number of the sub-LED blocks that are lighted by changing a current flow and a third controller (which controls the third current limiting device and the third switch block). When a point of time where each of the AC voltages supplied to a corresponding LED lighting block of the LED lighting blocks passes through a zero voltage and starts to increase is set to a voltage phase 0°, a current starts to be supplied to each of the LED lighting blocks and light emission starts before a voltage phase 30°. The first to third controllers respectively control the first to third current limiting devices with a sine wave signal (hereinafter referred to as a “sine wave one signal”) having a same phase as the rectified voltages.

In addition, it is preferred that the first to third controllers respectively control the first to third current limiting devices in a form of a staircase wave based on one of an instantaneous rectified voltage or a rectified voltage phase.

Furthermore, it is preferred that the first to third controllers generate a sine wave signal (hereinafter referred to as a “sine wave two signal”) that has a lower frequency than a rectified frequency, and respectively control the first to third current limiting devices such that a current corresponding to the sine wave two signal is supplied to the load.

In addition, it is preferred that the first LED block include a light emitting block in which two or more sub-LED blocks are connected in series, and the first LED lighting block further includes a first switch block (composed of one or more switches) which adjusts a number of the sub-LED blocks that are lighted by changing a current flow and a first controller (which controls the first current limiting device and the first switch block), and that the second LED block include a light emitting block in which two or more sub-LED blocks are connected in series, and the second LED lighting block further includes a second switch block (composed of one or more switches) which adjusts a number of the sub-LED blocks that are lighted by changing a current flow and a second controller (which controls the second current limiting device and the second switch block). The first and second controllers respectively control the first and second current limiting devices with a sine wave signal (hereinafter referred to as a “sine wave one signal”) having a same phase as the rectified voltages.

Furthermore, it is preferred that the first and second controllers respectively control the first and second current limiting devices in a form of a staircase wave based on one of an instantaneous rectified voltage or a rectified voltage phase.

In addition, it is preferred that the first and second controllers generate a sine wave signal (hereinafter referred to as a “sine wave two signal”) that has a lower frequency than a rectified frequency, and respectively control the first and second current limiting devices such that a current corresponding to the sine wave two signal is supplied to the load.

In direct drive LED lighting apparatuses of the related art which drive LED lamps using a rectified voltage without using a switching-mode power supply (SMPS), percent flicker (hereinafter referred to as “% F”) is 100%. In contrast, the % F of the LED lighting apparatus having improved flicker performance according to the present invention is equal to or better than the % F (40% or less) of fluorescent lamps using a magnetic ballast.

### BRIEF DESCRIPTION OF DRAWINGS

FIG. 1 is a view showing an LED lighting apparatus.

FIG. 2 is a voltage-current characteristic curve of the LED block.

FIG. 3 is a current waveform of the LED block.

FIG. 4 is a view showing another LED lighting apparatus.

FIG. 5 is a view showing a flicker calculation method.

FIG. 6 shows examples of flicker calculation depending on waveforms.

FIG. 7 is a graph produced by modeling LED light outputs.

FIG. 8 is another graph produced by modeling LED light emission.

FIG. 9 is a graph of rectified voltage waveforms of a three-phase voltage.

FIG. 10 shows a set of waveforms produced by simulating light outputs depending on the respective phases of the three-phase voltage.

FIG. 11 shows another set of waveforms produced by simulating light outputs depending on the respective phases of the three-phase voltage.

FIG. 12 is a graph produced by summing the light outputs of the respective phases of the three-phase voltage.

FIG. 13 is a table produced by calculating flicker quality indices of the three-phase voltage.

FIG. 14 shows a set of waveforms produced by simulating light outputs depending on the respective phases of a two-phase voltage.

FIG. 15 is a graph produced by summing the light outputs of the respective phases of the two-phase voltage.

FIG. 16 shows another set of waveforms produced by simulating light outputs depending on the respective phases of the two-phase voltage.

FIG. 17 is a graph produced by summing the light outputs of the respective phases of the two-phase voltage.

FIG. 18 is a table produced by calculating flicker quality indices of the two-phase voltage.

### DETAILED DESCRIPTION OF THE INVENTION

The present invention will now be described more fully hereinafter with reference to the accompanying drawings, in which exemplary embodiments thereof are shown. Above all, reference should be made to the drawings, in which the same reference numerals and signs are used throughout the different drawings to designate the same or similar components. The terminologies or words used in the description and the Claims of the present invention should not be interpreted as being limited merely to common and dictionary meanings. On the contrary, they should be interpreted based on the meanings and concepts in compliance with the scope of the present invention. In the following description of the present invention, detailed descriptions of known features and functions incorporated herein will be omitted when they may make the subject matter of the present invention rather unclear.

The key concept of the present invention is to set the percent flicker (hereinafter referred to as “% F”) of a lighting apparatus to be equal to or better than the % F of a conventional magnetic fluorescent lamp by disposing LED lighting blocks, the % F of which is 100%, at two or more phases of a three-phase alternating current (AC) power supply.

<Method of Calculating Flicker Quality Index>

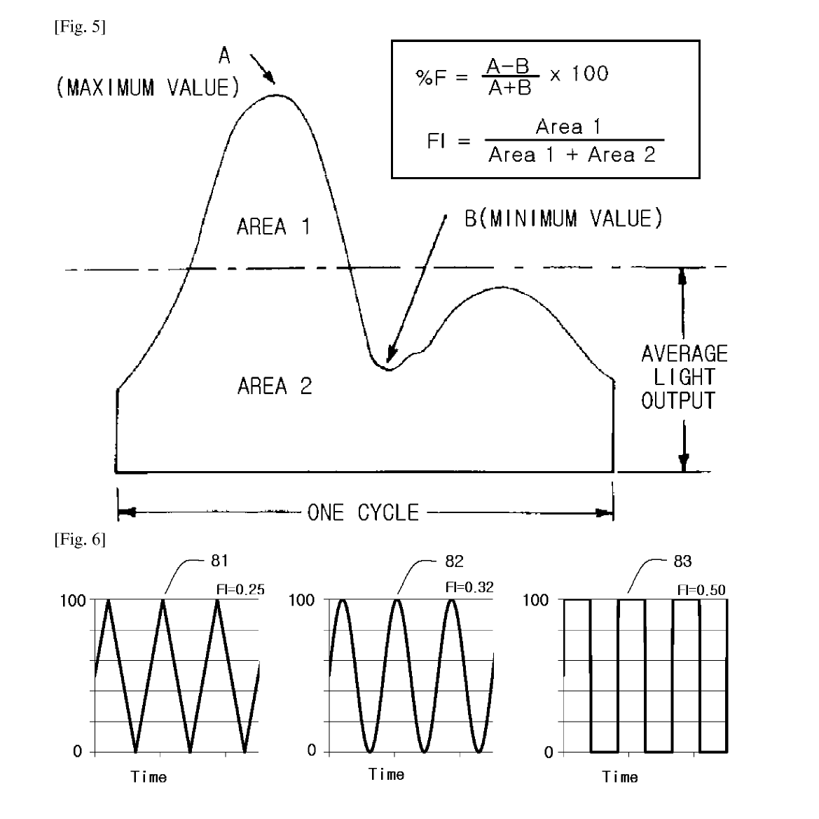

With reference to FIG. 5 and FIG. 6, a description will given below of a method of calculating a percent flicker (hereinafter referred to as “% F”) and a flicker index (hereinafter “FI”) that are flicker quality indices used for illumination.

FIG. 5 shows a flicker calculation method quoted from “IESNA Lighting Handbook, 9th Edition,” published by the Illuminating Engineering Society of North America (hereinafter referred to as “IESNA”).

First, in FIG. 5, % F is calculated using the maximum instantaneous light output and the minimum instantaneous light output, as presented in Formula 1:

% F=(A−B)/(A+B)×100 Formula 1

When the instantaneous minimum value of light is 0, % F is 100%.

The flicker quality index % F is indicated with a value ranging from 0 to 100%, with a lower value indicating better quality. % F is widely known and generally used, and is also referred to as peak-to-peak contrast, Michelson contrast, modulation, modulation depth, or the like.

In addition, in FIG. 5, the other flicker quality index FI is calculated using light output areas, as presented in Formula 2:

FI=(Area 1)/(Area 1+Area 2) Formula 2

Specifying Formula 2, the numerator indicates the area of a light output that is equal to or greater than the average light output, and the denominator indicates the area of the total light output. That is, Formula 2 indicates the ratio of the area of the light output equal to or greater than the average light output with respect to the area of the total light output. FI is indicated with a value ranging from 0 to 1.0, with a lower value indicating better quality.

FIG. 6 shows calculation examples of the flicker quality indices % F and FI. In light output waveforms, a triangular wave 81 indicates an FI of 0.25, a sine wave 82 indicates an FI of 0.32, and a square wave 83 indicates an FI of 0.50. Since all of the three cases have portions where the instantaneous light output is 0, % F is 100%.

Referring to the relationship between % F and FI, an improvement (lowering) in % F causes an increase in the average value, thereby reducing Area 1, which is the area of the light output that is equal to or greater than the average light output. This consequently reduces the numerator of Formula 2 above, thereby improving (lowering) FI.

<Light Output Model: Triangular Wave>

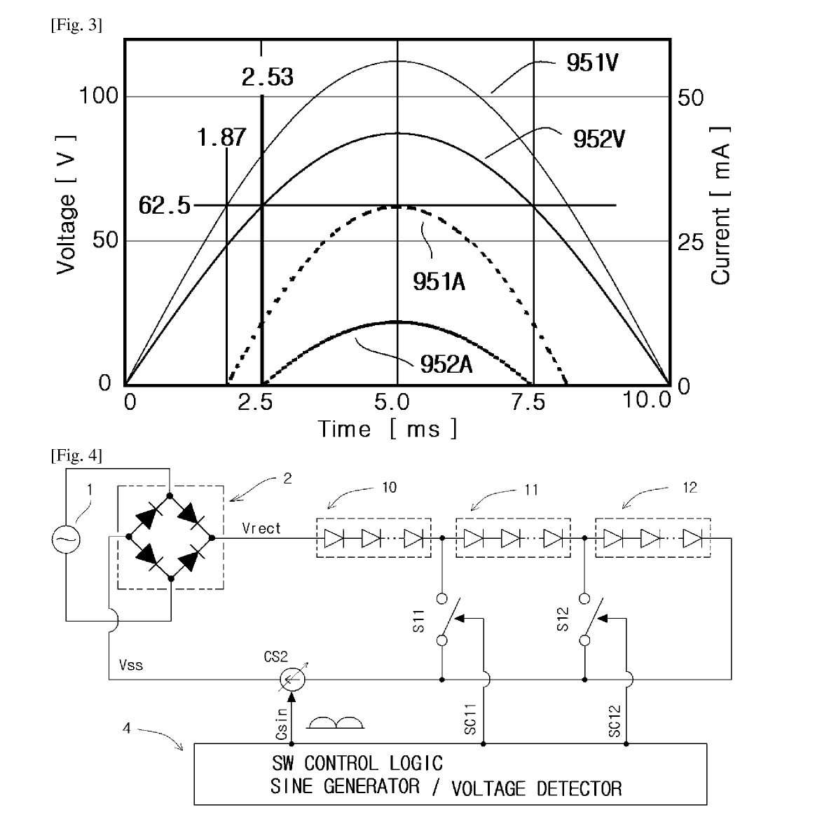

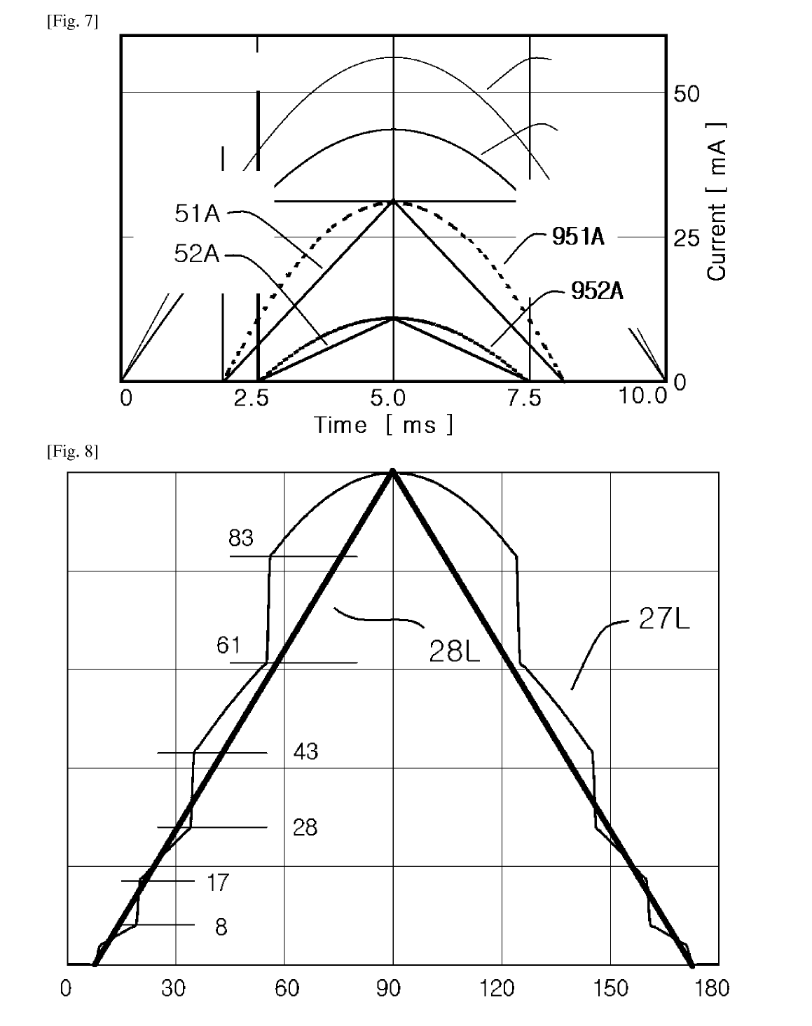

FIG. 7 is a view partially quoted from FIG. 3. Since a light output from the LED block 970 is proportional to the amount of current that flows through the LED block 970, a current waveform 951A and a current waveform 952A can be regarded as instantaneous light outputs.

For the sake of convenience of calculation, % F stays at 100% without a change even if the current waveform 951A is calculated through approximation to a triangular current waveform 51A. That is, % F can be quickly calculated by modeling the light outputs from the light emitting block.

It can be expected that the FI of the current waveform 951A is higher than the FI of the triangular current waveform 51A (since the FI of the triangular wave is 0.25 and the FI of the sine wave is 0.32 in FIG. 6). The current waveform 951A is produced by approximating the current-voltage characteristic curve 950 of the LED block 970 in FIG. 2 to the linear model 951. In this model, the current waveform 951A supplies more current than the actual current.

As a result, since a greater current was calculated from the linear model 951 of the LED block and a smaller current was calculated from the light output triangular wave model 51A, the calculated value of light output will be similar to an actual value due to cancellation. This will be useful for the calculation of FI. This is of course the same as in the case in which the current waveform 952A is approximated to a triangular current waveform 52A.

FIG. 8 shows an embodiment of a light output model 27L in the case in which the light emitting block of the circuit shown in FIG. 4 is configured with four sub-light emitting blocks, and the current limiting device CS2 supplies a load current in the form of a sine wave. The horizontal axis is rectified voltage phase, whereas the vertical axis is light output. The light output is normalized by setting a light output value at a rectified voltage phase 90° to be 100. (A description of the method of supplying a load current in the form of a sine wave will be omitted since it is described in detail in Korean Patent No. 10-1110380 of the inventor.)

Specifying the light output model 27L, when one sub-light emitting block is lighted, the instantaneous light output ranges from 0 to 8. When two sub-light emitting blocks are lighted, the instantaneous light output ranges from 17 to 28. When three sub-light emitting blocks are lighted, the instantaneous light output ranges from 43 to 61. When four sub-light emitting blocks are lighted, the instantaneous light output ranges from 83 to 100.

There is a section where the light output increases vertically from 8 to 17. This is due to a phenomenon in which the entire light output is increased by the addition of one sub-light emitting block even if a small amount of current is increased since the load current is limited to the sine wave by the current limiting device CS2.

Descriptions of the case in which the three sub-light emitting blocks start to be lighted (i.e. the vertical increase from 28 to 43) and the case in which the four sub-light emitting blocks start to be lighted (i.e. the vertical increase from 61 to 83) will be omitted for the sake of convenience of explanation since they can be analyzed.

Describing in greater detail the light output model 27L shown in FIG. 8, the instantaneous light output 8 before the two light emitting blocks were lighted was substantially doubled to 17 right after the two light emitting blocks were lighted. In brief, when the number of the light emitting blocks that were lighted was increased from 1 to 2 with the current remaining unchanged, the light output was doubled.

In addition, the instantaneous light output 28 before the three light emitting blocks were lighted was increased to the instantaneous light output 43 right after the three light emitting blocks were lighted. That is, the light output was increased to be about 3/2. In brief, when the number of the light emitting blocks that were lighted was increased from 2 to 3 with the current remaining unchanged, the light output was increased to be 3/2.

In addition, the instantaneous light output 61 before the four light emitting blocks were lighted was increased to the instantaneous light output 83 right after the four light emitting blocks were lighted. That is, the light output was increased to be about 4/3. In brief, when the number of the light emitting blocks that were lighted was increased from 3 to 4 with the current remaining unchanged, the light output was increased to be 4/3.

As described above, it can be appreciated that the light output model 27L is properly set in the theoretical basis.

Referring to FIG. 8, it is apparent that the light output model 27L is substantially identical to a triangular model 28L around a rectified voltage phase 0°. When the light output model 27L is approximated to the triangular model 28L for the sake of convenience of calculation, % F will stay 100% without a change. Therefore, it is apparent that % F can be rapidly calculated by modeling the output of light from the light emitting blocks into the triangular wave.

In addition, even if the current increases in the form of a staircase wave (the section ranging from 17 to 28, the section ranging from 43 to 61, and the section ranging from 83 to 100) in FIG. 8, it is of course possible to calculate % F and FI based on the light output triangular model.

As such, the method of calculating the quality indices the % F and FI of the lighting apparatus by modeling the output of light in the form of a triangular wave was described hereinabove.

Since % F is calculated using the maximum instantaneous light output and the minimum instantaneous light output, the overall tendency does not significantly change even if the light output model is slightly inaccurate. FI automatically improves (decreases) when the % F value improves (reduces) (i.e. when the average value increases). Therefore, the following description will be focused on % F.

### First Embodiment

### 3-Phase AC Power

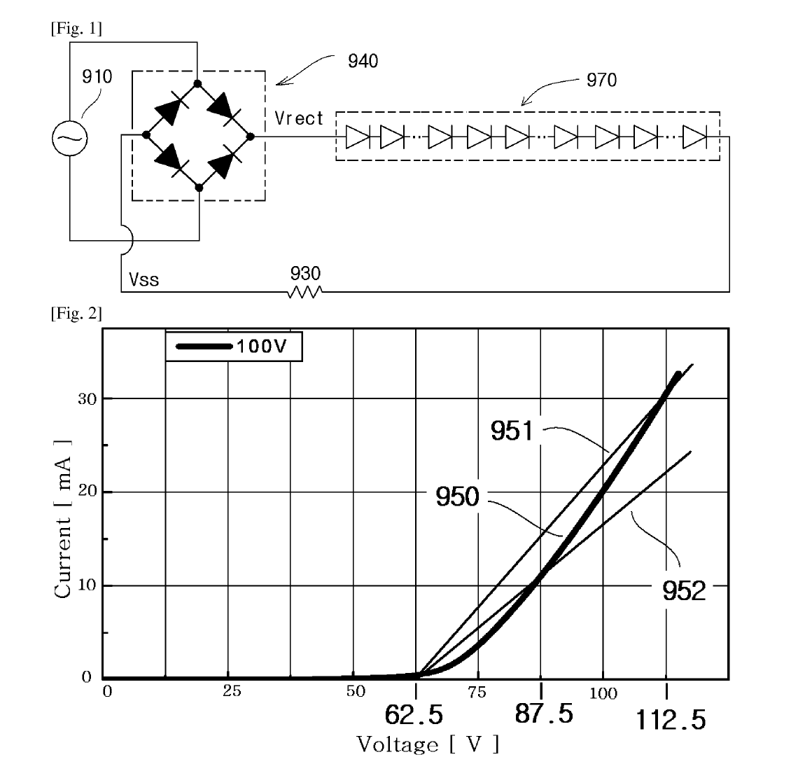

The first embodiment of the present invention is a specific embodiment in which % F and FI are calculated when the LED lighting apparatus (referring to the entire circuit shown in FIG. 1 or FIG. 4) is provided on the respective phases of a three-phase power supply (hereinafter, the LED lighting apparatus disposed on the respective phases of the three-phase power supply will be referred to as the “LED lighting block”).

The circuit configuration employed in the first embodiment includes an AC power supply which supplies a first-phase AC voltage; a first LED lighting block which is driven by the first-phase AC voltage; an AC power supply which supplies a second-phase AC voltage; a second LED lighting block which is driven by the second-phase AC voltage; an AC power supply which supplies a third-phase AC voltage; and a third LED lighting block which is driven by the third-phase AC voltage.

Describing the first LED lighting block in detail, the first LED lighting block includes a first rectifier circuit which rectifies the first-phase AC voltage; a first LED block composed of one or more LEDs which are driven by an output from the first rectifier circuit; and a first current source (hereinafter also referred to as a “first current limiting device”) which adjusts the amount of current supplied to the first LED block.

Describing the second lighting block in detail, the second LED lighting block includes a second rectifier circuit which rectifies the second-phase AC voltage; a second LED block composed of one or more LEDs which are driven by an output from the second rectifier circuit; and a second current source (hereinafter also referred to as a “second current limiting device”) which adjusts the amount of current supplied to the second LED block.

In addition, describing the third lighting block in detail, the third LED lighting block includes a third rectifier circuit which rectifies the third-phase AC voltage; a third LED block composed of one or more LEDs which are driven by an output from the third rectifier circuit; and a third current source which adjusts the amount of current supplied to the third LED block (hereinafter also referred to as a “third current limiting device”).

Here, each of the first to third LED blocks can include a plurality of sub-LED blocks which are connected in series. In addition, each LED lighting block can include a switch block (composed of one or more switches) which adjusts the number of the sub-LED blocks that are lighted by changing the flow of current through the respective sub-LED blocks. Here, it is preferred that each LED lighting block include a controller which controls the switch block.

It is preferred that the controller of each LED lighting block improve a power factor by controlling the current limiting device such that a low load current flows at a low instantaneous rectified voltage and a high load current flows at a high instantaneous rectified voltage when one cycle of rectified voltage is supplied.

Here, it is preferred that the controller of each LED lighting block control the current limiting device such that a staircase current is supplied to the load based on the instantaneous rectified voltage.

In addition, it is preferred that the controller of each LED lighting block control the current limiting device such that a staircase current is supplied to the load based on the rectified voltage phase.

Furthermore, as described in Korean Patent No. 10-1110380 of the inventor, the controller of each LED lighting block further has the function of generating a sine wave signal (hereinafter referred to as a “sine wave one signal”) that has the same phase as the rectified voltage of each LED lighting block, and preferably controls the current limiting device such that a current (hereinafter referred to as a “sine wave one current”) corresponding to the sine wave one signal is supplied to the load.

The controller of each LED lighting block generates the sine wave one signal that has the same phase as the rectified voltage in order to improve the power factor since the AC current supplied from the AC power supply of each LED lighting block has the same phase as the AC voltage and is in the form of a sine wave. In addition, the load current flowing through the load is of course produced by rectifying the AC current.

In addition, the controller of each LED lighting block generates a sine wave signal (hereinafter referred to as a “sine wave two signal”) that has a lower frequency than a rectified frequency (twice the frequency of the AC power), and preferably controls the current limiting device such that a current (hereinafter referred to as a “sine wave two current”) corresponding to the sine wave two signal is supplied to the load. Here, it is preferred that the maximum instantaneous voltage of the sine wave two signal occur at each rectified voltage phase 90°.

This is because the LED lighting apparatus can provide brighter light although the harmonic wave content of the supply current is higher than that of the sine wave one current. For instance, the Republic of Korea regulates that the harmonic wave content of the supply current of low-power LED lighting apparatuses (using, for example, 25 W or less) be 30% or less. In contrast, according to the sine wave one current, the harmonic wave content of the supply current is theoretically 0% in the case of a typical resistance load, and can be 1% or lower in the case of the LED lighting apparatus. Therefore, it is desirable to improve the brightness of the LED lighting apparatus even though its power factor is slightly lowered since the harmonic wave content of the supply current is insignificantly increased (so as not to exceed the regulated value of 30%).

Here, it is desirable to control the current limiting device of each lighting block in order to supply the staircase current to the load based on the sine wave two signal.

As described above, there is a number of methods for supplying the current to the load. Since these methods do not form the key concept of the present invention, in order to avoid repeated descriptions, the modeling of light outputs with a triangular wave when the sine wave one current is supplied to the load will be representatively described.

It is preferred that each of the first to third LED blocks include one or more LEDs, or a plurality of LEDs which are arranged in series or parallel in each LED block. Since the LED blocks can be formed using the well-known technologies, detailed descriptions thereof will be omitted for the sake of convenience of explanation.

The method of controlling the switch block such that a number of LED blocks are connected in series, the number of LED blocks being suitable for the instantaneous rectified voltage, the method of supplying the staircase current based on the instantaneous rectified voltage to the load, the method of supplying the staircase current based on the instantaneous rectified voltage phase to the load, and the method of supplying the sine wave one current to the load can be embodied based on the well-known technologies, including Korean Patent Nos. 10-1110380 and 10-1043533 of the inventor. Therefore, detailed descriptions thereof will be omitted herein for the sake of convenience of explanation.

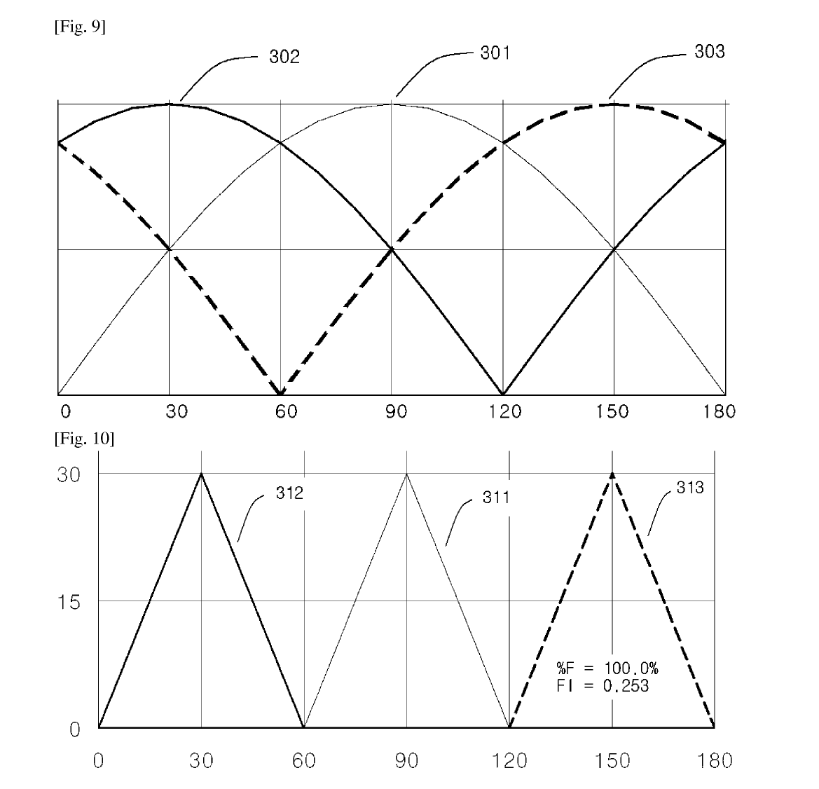

Reference will now be made of the first embodiment of the present invention in conjunction with FIG. 9 and FIG. 10.

First, those shown in FIG. 9 are produced by rectifying a three-phase AC voltage. Specifically, a first-phase rectified voltage 301 starting at a voltage phase 0° has the maximum instantaneous rectified voltage at a voltage phase 90°. Following a second-phase rectified voltage 302 starting at a voltage phase 120°, the maximum instantaneous rectified voltage occurs at a voltage phase 30°. In addition, a third-phase rectified voltage 303 starting at a voltage phase 240° has the maximum instantaneous rectified voltage at a voltage phase 150°. Thus, the maximum instantaneous rectified voltages of the respective phases occur at 30, 90 and 150°.

A description will be given below of boundary conditions (a light emission start phase) where % F is 100% using a triangular model with reference to FIG. 10.

A light output triangular wave model 311 of the first lighting block will be described first. The first-phase rectified voltage 301 starts at the voltage phase 0° and has the maximum instantaneous rectified voltage at the voltage phase 90°. According to the light output triangular wave model 311, the output of light is 0 in the range from the voltage phase 0° to the voltage phase 60°. Light starts to be emitted at the voltage phase 60°, and the output of light linearly increases so as to be the maximum at the voltage phase 90° where the maximum instantaneous rectified voltage of the first-phase rectified voltage 301 occurs. After the voltage phase 90°, the output of light decreases at the same inclination having the opposite sign. The output of light then becomes 0, which remains unchanged before the start of the next rectified voltage cycle. In brief, the light output triangular wave model 311 is a model that starts to emit light at 60° after the phase of the first-phase rectified voltage 301, has the maximum light output at the maximum instantaneous rectified voltage, stops emitting light at the phase that is 60° before the rectified voltage phase. In addition, the % F of the light output triangular wave model 311 is 100%.

A light output triangular wave model 312 of the second LED lighting block and a light output triangular wave model 313 of the third LED lighting block are embodied based on the same principle as that of the light output triangular wave model 311 of the first LED lighting block, and thus descriptions thereof will be omitted for the sake of convenience of explanation.

When % F and FI are calculated by summing the instantaneous light outputs of the light output triangular wave models 311 to 313, % F is 100% and FI is 0.253. This explains that light emission must start before the rectified voltage phase 60° of each phase in order to improve (reduce) % F.

A description will be given below of an example in which % F is improved using a triangular model.

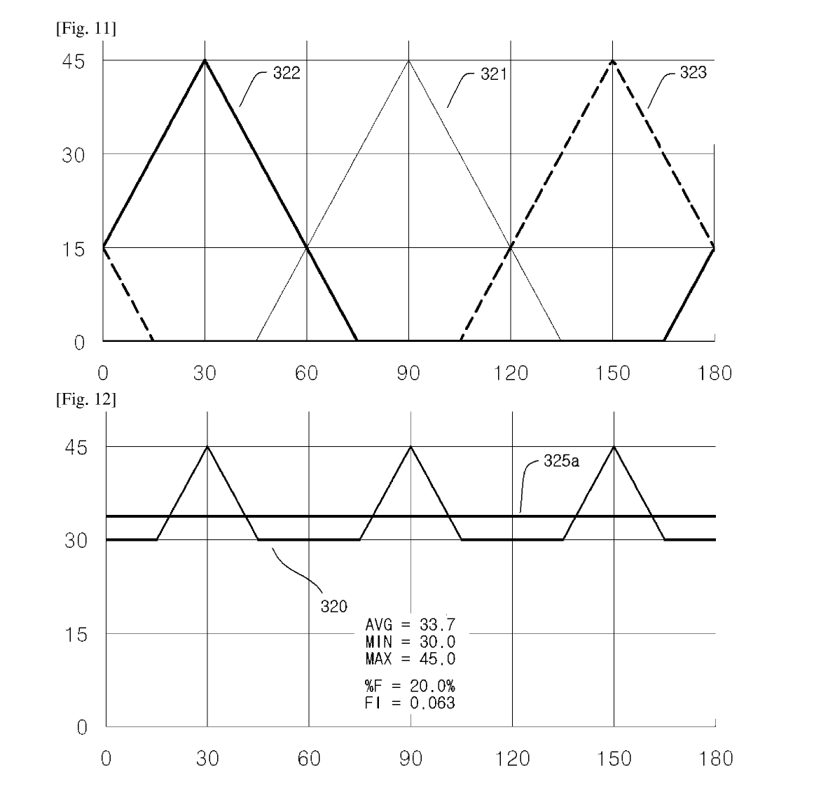

Referring to FIG. 11, a light output triangular wave model 321 is a model that starts to emit light at 45° after the phase of the first-phase rectified voltage 301, has the maximum light output at the maximum instantaneous rectified voltage, stops emitting light at the phase that is 45° before the rectified voltage phase. In addition, the % F of the light output triangular wave model 321 is 100%.

A light output triangular wave model 322 of the second LED lighting block and a light output triangular wave model 323 of the third LED lighting block are embodied based on the same principle as that of the light output triangular wave model 321 of the first LED lighting block, and thus descriptions thereof will be omitted for the sake of convenience of explanation.

Referring to FIG. 12, an average instantaneous light waveform 320 is produced by averaging a total of the instantaneous light outputs of the light output triangular wave models 321 to 323. When % F and FI are calculated using the average instantaneous light waveform 320, % F is 20% and FI is 0.063. A linear waveform 325a represents an average light output between the voltage phase 0 and 180°.

As such, with reference to FIG. 11 and FIG. 12, the foregoing description was given of the example in which the % F of the LED lighting block is 100% at the single-phase power and is improved to 20% when the LED lighting block is applied to the three-phase power.

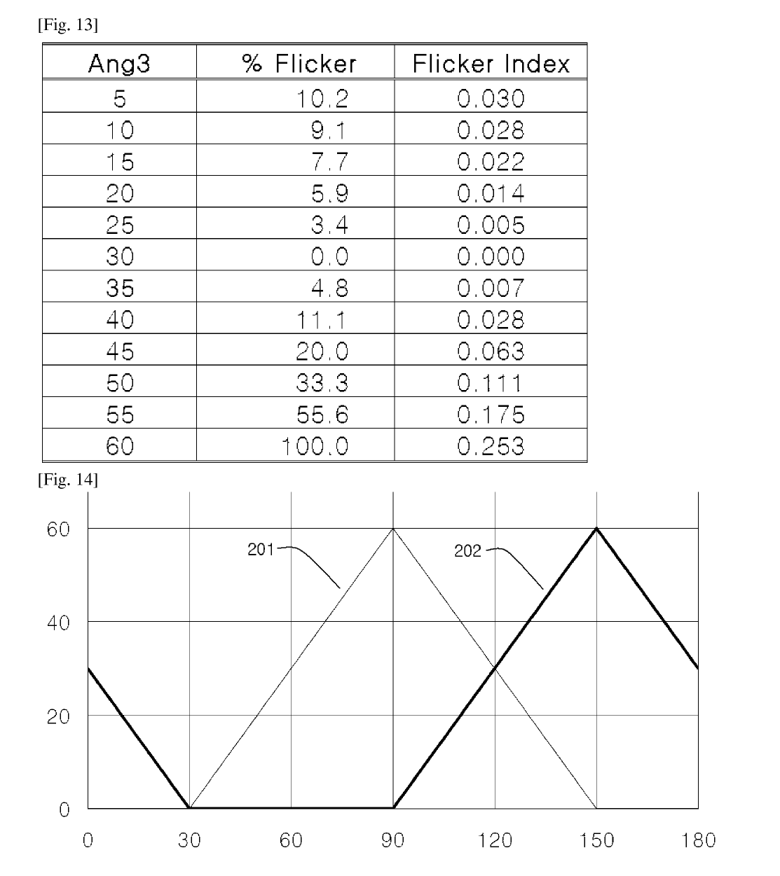

FIG. 13 is a table presenting results produced by calculating various values of light emission start phases based on the principle applied to FIG. 10 to FIG. 12. In this table, a column “Ang3” represents voltage phases at which a lighting block of each phase starts to emit light, a column “% Flicker” represents results produced by calculating values of % F, and a column “Flicker Index” represents results produced by calculating values of FI.

Referring to several numerical values, it can be appreciated that % F is 20% at a light emission start phase 45°, 11.1% at a light emission start phase 40°, and 4.8% at a light emission start phase 35°. Unusually, % F and FI are 0 at a light emission start phase 30°. The earlier than 30° the light emission start phase is, the worse % F becomes. % F is 10.2% at a light emission start phase 5°.

Considering the accuracy of the light output model employed in the present invention and the difference in the brightness between LEDs, it is desirable to start light emission before a rectified voltage phase 40° in order to realize the % F of 11.1% or less. It is also desirable to start light emission before a rectified voltage phase 30° since % F is 0% when light emission starts at the light emission start phase 30°.

As such, the modeling of light outputs with a triangular wave when the sine wave one current is supplied to the load was representatively described hereinabove. When the staircase current based on the instantaneous rectified voltage, the staircase current based on the rectified voltage phase and the sine wave two current are supplied to the load, the output of light is modeled with the triangular wave model and % F is calculated without departing from the concept of the present invention.

### Second Embodiment

### Two Phase

The second embodiment of the present invention is a specific embodiment in which % F and FI are calculated when the LED lighting apparatus (referring to the entire circuit shown in FIG. 1 or FIG. 4) is provided on two phases of a three-phase power supply (hereinafter, the LED lighting apparatus disposed on the two phases of the three-phase power supply will be referred to as the “LED lighting block”).

The circuit configuration employed in the second embodiment includes an AC power supply which supplies a first-phase AC voltage; a first LED lighting block which is driven by the first-phase AC voltage; an AC power supply which supplies a second-phase AC voltage; and a second LED lighting block which is driven by the second-phase AC voltage.

Describing the first LED lighting block in detail, the first LED lighting block includes a first rectifier circuit which rectifies the first-phase AC voltage; a first LED block composed of one or more LEDs which are driven by an output from the first rectifier circuit; and a first current source (hereinafter also referred to as a “first current limiting device”) which adjusts the amount of current supplied to the first LED block.

Describing the second LED lighting block in detail, the second LED lighting block includes a second rectifier circuit which rectifies the second-phase AC voltage; a second LED block composed of one or more LEDs which are driven by an output from the second rectifier circuit; and a second current source (hereinafter also referred to as a “second current limiting device”) which adjusts the amount of current supplied to the second LED block.

Here, each of the first and second LED blocks can include a plurality of sub-LED blocks which are connected in series. In addition, each LED lighting block can include a switch block (composed of one or more switches) which adjusts the number of the sub-LED blocks that are lighted by changing the flow of current. Here, it is preferred that each LED lighting block include a controller which controls the switch block.

It is preferred that the controller of each LED lighting block improve a power factor by controlling the current limiting device such that a low load current flows at a low instantaneous rectified voltage and a high load current flows at a high instantaneous rectified voltage when one cycle of rectified voltage is supplied.

Here, it is preferred that the controller of each LED lighting block control the current limiting device such that a staircase current is supplied to the load based on the instantaneous rectified voltage.

In addition, it is preferred that the controller of each LED lighting block control the current limiting device such that a staircase current is supplied to the load based on the rectified voltage phase.

Furthermore, as described in Korean Patent No. 10-1110380 of the inventor, the controller of each LED lighting block further has the function of generating a sine wave signal (hereinafter referred to as a “sine wave one signal”) that has the same phase as the rectified voltage of each LED lighting block, and preferably controls the current limiting device such that a current (hereinafter referred to as a “sine wave one current”) corresponding to the sine wave one signal is supplied to the load.

The controller of each LED lighting block generates the sine wave one signal that has the same phase as the rectified voltage in order to improve the power factor since the AC current supplied from the AC power supply of each LED lighting block has the same phase as the AC voltage and is in the form of a sine wave. In addition, the load current flowing through the load is of course produced by rectifying the AC current.

In addition, the controller of each LED lighting block generates a sine wave signal (hereinafter referred to as a “sine wave two signal”) that has a lower frequency than a rectified frequency (twice the frequency of the AC power), and preferably controls the current limiting device such that a current (hereinafter referred to as a “sine wave two current”) corresponding to the sine wave two signal is supplied to the load. Here, it is preferred that the maximum instantaneous voltage of the sine wave two signal occur at each rectified voltage phase 90°.

This is because the LED lighting apparatus can provide brighter light although the harmonic wave content of the supply current is higher than that of the sine wave one current. For instance, the Republic of Korea regulates that the harmonic wave content of the supply current of low-power LED lighting apparatuses (using, for example, 25 W or less) be 30% or less. In contrast, according to the sine wave one current, the harmonic wave content of the supply current is theoretically 0% in the case of a typical resistance load, and can be 1% or lower in the case of the LED lighting apparatus. Therefore, it is desirable to improve the brightness of the LED lighting apparatus even though its power factor is slightly lowered since the harmonic wave content of the supply current is insignificantly increased (so as not to exceed the regulated value of 30%).

Here, it is desirable to control the current limiting device of each lighting block in order to supply the staircase current to the load based on the sine wave two signal.

As described above, there is a number of methods for supplying the current to the load. Since these methods do not form the key concept of the present invention, in order to avoid repeated descriptions, the modeling of light outputs with a triangular wave when the sine wave one current is supplied to the load will be representatively described.

It is preferred that each of the first and second LED blocks include one or more LEDs, or a plurality of LEDs which are arranged in series or parallel in each LED block. Since the LED blocks can be formed using the well-known technologies, detailed descriptions thereof will be omitted for the sake of convenience of explanation.

The method of controlling the switch block such that a number of LED blocks are connected in series, the number of LED blocks being suitable for the instantaneous rectified voltage, the method of supplying the staircase current based on the instantaneous rectified voltage to the load, the method of supplying the staircase current based on the instantaneous rectified voltage phase to the load, and the method of supplying the sine wave one current to the load can be embodied based on the well-known technologies, including Korean Patent Nos. 10-1110380 and 10-1043533 of the inventor. Therefore, detailed descriptions thereof will be omitted herein for sake of convenience of explanation.

Reference will now be made of the second embodiment of the present invention in conjunction with FIG. 9 and FIG. 14.

First, a description will be given of boundary conditions (a light emission start phase) where % F is 100% using a triangular model with reference to FIG. 14.

A light output triangular wave model 201 of the first lighting block will be described first. The first-phase rectified voltage 301 starts at the voltage phase 0° and has the maximum instantaneous rectified voltage at the voltage phase 90°. According to the light output triangular wave model 201, the output of light is 0 in the range from the voltage phase 0° to the voltage phase 30°. Light starts to be emitted at the voltage phase 30°, and the output of light linearly increases so as to be the maximum at the voltage phase 90° where the maximum instantaneous rectified voltage of the first-phase rectified voltage 301 occurs. After the voltage phase 90°, the output of light decreases at the same inclination having the opposite sign. The output of light then becomes 0, which remains unchanged before the start of the next rectified voltage cycle.

In brief, the light output triangular wave model 201 is a model that starts to emit light at 30° after the phase of the first-phase rectified voltage 301, has the maximum light output at the maximum instantaneous rectified voltage, stops emitting light at the phase that is 30° before the rectified voltage phase. In addition, the % F of the light output triangular wave model 201 is 100%.

A light output triangular wave model 202 of the second LED lighting block is embodied based on the same principle as that of the light output triangular wave model 201, and thus a description thereof will be omitted for the sake of convenience of explanation.

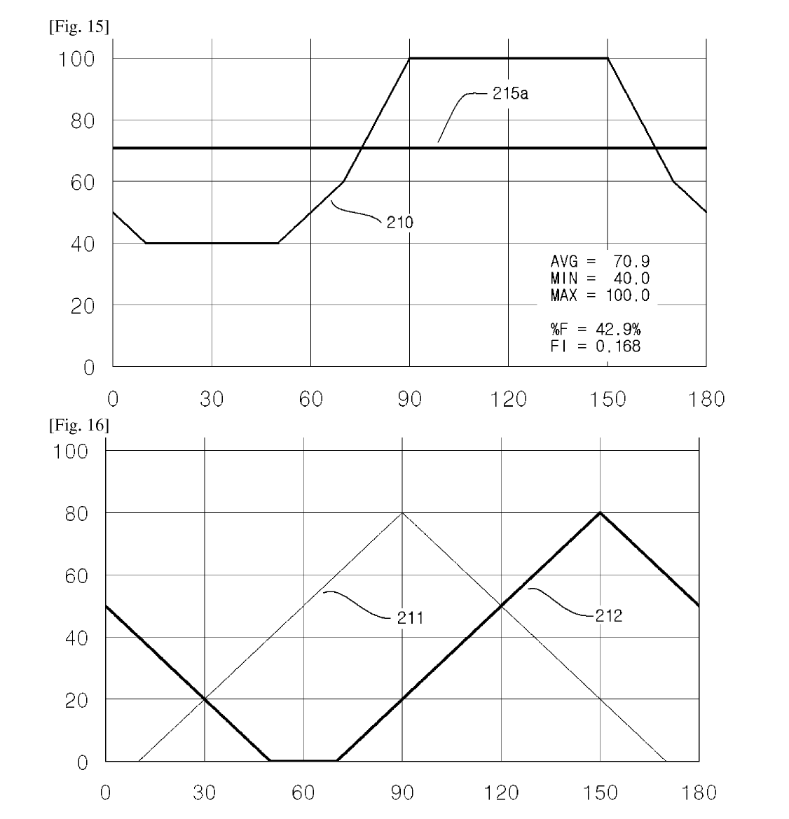

Referring to FIG. 15, an average instantaneous light waveform 200 is a waveform produced by averaging a total of the instantaneous light outputs of the light output triangular wave models 201 and 202. When % F and FI are calculated using the average instantaneous light waveform 200, % F is 100% and FI is 0.222. A linear waveform 205a represents an average light output between the voltage phase 0 and 180°.

This explains that light emission must start before the rectified voltage phase 30° of each phase in order to improve (reduce) % F.

A description will be given below of an example in which % F is improved using the triangular model.

Referring to FIG. 16, a light output triangular wave model 211 is a model that starts to emit light at 10° after the phase of the first-phase rectified voltage 301, has the maximum light output at the maximum instantaneous rectified voltage, stops emitting light at the phase that is 10° before the rectified voltage phase. In addition, the % F of the light output triangular wave model 211 is 100%.

A light output triangular wave model 212 of the second LED lighting block is embodied based on the same principle as that of the light output triangular wave model 211 of the first LED lighting block, and thus a description thereof will be omitted for the sake of convenience of explanation.

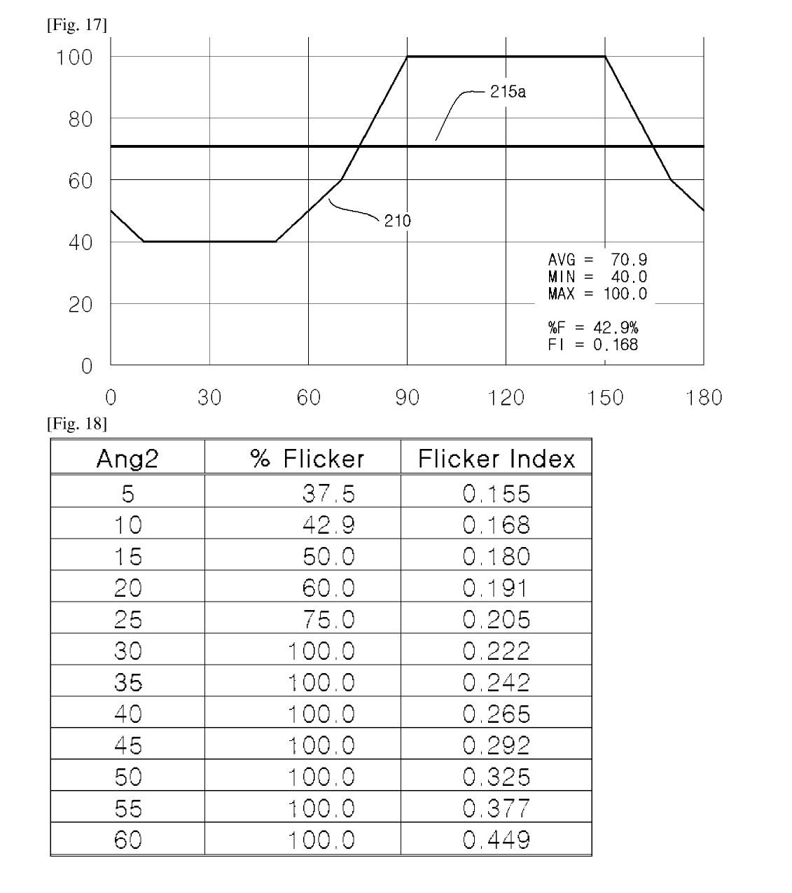

Referring to FIG. 17, an average instantaneous light waveform 210 is a waveform produced by averaging a total of the instantaneous light outputs of the light output triangular wave models 211 and 212. When % F and FI are calculated using the average instantaneous light waveform 210, % F is 42.9% and FI is 0.168. A linear waveform 215a represents an average light output between the voltage phase 0 and 180°.

As such, with reference to FIG. 16 and FIG. 17, the foregoing description was given of the example in which the % F of the LED lighting block is 100% at the single-phase power and is improved to 42.9% when the LED lighting block is applied to the two-phase power.

FIG. 18 is a table presenting results produced by calculating various values of light emission start phases based on the principle applied to FIG. 14 to FIG. 16. In this table, a column “Ang2” represents voltage phases at which a lighting block of each phase starts to emit light, a column “% Flicker” represents results produced by calculating values of % F, and a column “Flicker Index” represents results produced by calculating values of FI.

Referring to several numerical values, it can be appreciated that % F is 60% at a light emission start phase 20°, 50% at a light emission start phase 15°, 42.9% at a light emission start phase 10°, and 37.5% at a light emission start phase 5°.

Considering that the % F of a fluorescent lamp having a magnetic ballast ranges from 25 to 40%, it is desirable to start light emission before a rectified voltage phase 10°.

As such, the modeling of light outputs with a triangular wave when the sine wave current is supplied to the load was representatively described hereinabove. When the staircase current based on the instantaneous rectified voltage, the staircase current based on the rectified voltage phase and the sine wave two current are supplied to the load, the output of light is modeled with the triangular wave model and % F is calculated without departing from the concept of the present invention.

Although the exemplary embodiments of the present invention have been disclosed for illustrative purposes, a person skilled in the art will appreciate that various modified embodiments can be made therefrom. Therefore, the certain embodiments of the present invention disclosed in the description and the drawings are provided for better understanding of the description of the present invention and shall be interpreted as illustrative only but not as limitative of the scope of the present invention.

In the newly-growing LED lighting industry, the power supply that drives LEDs is divided into two types. The first type is the AC-DC converter type which supplies DC power. The AC-DC converter type has a superior light quality index, i.e. its % F is 40% or less. However, a high-power LED lamp is expensive since it requires an additional circuit, such as a power factor improvement circuit. In an inexpensive low-power LED lamp, a power factor or power quality index is low. In addition, since an electrolyte capacitor which contains liquid is used, the longevity of the LED lamp is limited by the longevity of a power supply.

The second type is the AC drive type using AC power, which does not require a power factor improvement circuit. Thus, the price competitiveness of the AC drive type is better than the AC-DC converter type. However, the AC drive type has a poor light quality index, i.e. its % F is 100%.

The AC drive technology according to the present invention enables key components of the newly-growing LED lighting industry to have superior light quality (% F of 40% or less) without a power factor improvement circuit. Thus, the present invention has price competitiveness and has high industrial applicability.

1. An LED lighting apparatus having improved flicker, comprising:
an AC power supply which supplies a first-phase AC voltage and a second-phase AC voltage;
first and second rectifier circuits which convert the AC voltages into DC rectified voltages;
first and second LED blocks each including one or more LEDs as a load;
first and second current limiting devices each of which limits an amount of current;
a first LED lighting block comprising the first rectifier circuit which rectifies the first-phase AC voltage, a first LED block which is driven by an output from the first rectifier circuit, and the first current limiting device which limits the amount of current of the first LED block; and
a second LED lighting block comprising the second rectifier circuit which rectifies the second-phase AC voltage, a second LED block which is driven by an output from the second rectifier circuit, and the second current limiting device which limits the amount of current of the second LED block,
wherein, when a point of time where each of the AC voltages supplied to a corresponding LED lighting block of the LED lighting blocks passes through a zero voltage and starts to increase is set to a voltage phase 0°, a current starts to be supplied to each of the LED lighting blocks and light emission starts before a voltage phage 10°, and a percent flicker of each of the LED lighting blocks is 100%.

2. The LED lighting apparatus according to claim 1, further comprising:
a third LED lighting block comprising an AC power supply which supplies a third-phase AC voltage;
a third rectifier circuit which rectifies the third-phase AC voltage;
a third LED block which is driven by an output from the third rectifier circuit; and a third current limiting device which limits an amount of current of the third LED block,
wherein, when a point of time where each of the AC voltages supplied to a corresponding LED lighting block of the LED lighting blocks passes through a zero voltage and starts to increase is set to a voltage phase 0°, a current starts to be supplied to each of the LED lighting blocks and light emission starts before a voltage phage 40°, and a percent flicker of each of the LED lighting blocks is 100%.

3. The LED lighting apparatus according to claim 2,
wherein the first LED block comprises a light emitting block in which two or more sub-LED blocks are connected in series, and the first LED lighting block further includes a first switch block (composed of one or more switches) which adjusts a number of the sub-LED blocks that are lighted by changing a current flow and a first controller (which controls the first current limiting device and the first switch block),
wherein the second LED block comprises a light emitting block in which two or more sub-LED blocks are connected in series, and the second LED lighting block further includes a second switch block (composed of one or more switches) which adjusts a number of the sub-LED blocks that are lighted by changing a current flow and a second controller (which controls the second current limiting device and the second switch block),
wherein the third LED block comprises a light emitting block in which two or more sub-LED blocks are connected in series, and the third LED lighting block further includes a third switch block (composed of one or more switches) which adjusts a number of the sub-LED blocks that are lighted by changing a current flow and a third controller (which controls the third current limiting device and the third switch block),
wherein, when a point of time where each of the AC voltages supplied to a corresponding LED lighting block of the LED lighting blocks passes through a zero voltage and starts to increase is set to a voltage phase 0°, a current starts to be supplied to each of the LED lighting blocks and light emission starts before a voltage phage 30°, and
wherein the first to third controllers respectively control the first to third current limiting devices with a sine wave signal (hereinafter referred to as a “sine wave one signal”) having a same phase as the rectified voltages.

4. The LED lighting apparatus according to claim 3, wherein the first to third controllers respectively control the first to third current limiting devices in a form of a staircase wave based on one of an instantaneous rectified voltage or a rectified voltage phase.

5. The LED lighting apparatus according to claim 3, wherein the first to third controllers generate a sine wave signal (hereinafter referred to as a “sine wave two signal”) that has a lower frequency than a rectified frequency, and respectively control the first to third current limiting devices such that a current corresponding to the sine wave two signal is supplied to the load.

6. The LED lighting apparatus according to claim 1, wherein the first LED block comprises a light emitting block in which two or more sub-LED blocks are connected in series, and the first LED lighting block further includes a first switch block (composed of one or more switches) which adjusts a number of the sub-LED blocks that are lighted by changing a current flow and a first controller (which controls the first current limiting device and the first switch block), wherein the second LED block comprises a light emitting block in which two or more sub-LED blocks are connected in series, and the second LED lighting block further includes a second switch block (composed of one or more switches) which adjusts a number of the sub-LED blocks that are lighted by changing a current flow and a second controller (which controls the second current limiting device and the second switch block), and wherein the first and second controllers respectively control the first and second current limiting devices with a sine wave signal (hereinafter referred to as a “sine wave one signal”) having a same phase as the rectified voltages.

7. The LED lighting apparatus according to claim 6, wherein the first and second controllers respectively control the first and second current limiting devices in a form of a staircase wave based on one of an instantaneous rectified voltage or a rectified voltage phase.

8. The LED lighting apparatus according to claim 6, wherein the first and second controllers generate a sine wave signal (hereinafter referred to as a “sine wave two signal”) that has a lower frequency than a rectified frequency, and respectively control the first and second current limiting devices such that a current corresponding to the sine wave two signal is supplied to the load.
